(19) United States
(12) Patent Application Publication
(10) Pub. No.: US 2025/0191208 A1
(43) Pub. Date: Jun. 12, 2025

(54) SYSTEMS AND METHODS FOR DEPTH CHARACTERIZATION

(71) Applicant: Sanctuary Cognitive Systems Corporation, Vancouver (CA)

(72) Inventor: Mani Ranjbar, Port Coquitlam (CA)

(21) Appl. No.: 18/973,079

(22) Filed: Dec. 8, 2024

Related U.S. Application Data
(60) Provisional application No. 63/607,668, filed on Dec. 8, 2023.

(51) Int. Cl. G06T 7/593; G06T 7/70

(52) U.S. Cl. CPC G06T 7/593; G06T 7/70; G06T 2207/10012; G06T 2207/30248

(57) ABSTRACT

In an implementation, a stereo vision system comprises a first, a second, and a third camera. The first and second cameras are separated by a first baseline, the second and third cameras by a second baseline, and the first and third cameras by a third baseline. The third baseline is greater than the second baseline which is greater than the first baseline. The stereo vision system is operable to determine a first depth characterization of a first object using data received from the first camera and the second camera, determine a second depth characterization of a second object using data received from the second camera and the third camera, and determine a third depth characterization of a third object using data received from the first camera and the third camera. The third object is farther away than the second object which is farther away than the first object.

### TECHNICAL FIELD

The present systems, devices, and methods generally relate to depth characterization, and particularly relate to stereo vision systems in robots.

### BACKGROUND

Robots are machines that can assist humans or substitute for humans. Robots can be used in diverse applications including construction, manufacturing, monitoring, exploration, learning, and entertainment. Robots can be used in dangerous or uninhabitable environments, for example. In various of these applications, robots can be allocated to a task.

Some robots require user input, and can be operated by humans. Other robots have a degree of autonomy, and can operate, in at least some situations, without human intervention. Some autonomous or semi-autonomous robots are designed to mimic human behavior. Autonomous or semi-autonomous robots can be particularly useful in applications where robots (for example, general purpose robots) are needed to work for an extended time without operator intervention, to navigate within their operating environment, and/or to adapt to changing circumstances.

Some robots are mobile and able to move about, autonomously, or otherwise, within their environment. While performing some tasks, a robot may be tethered to a source of electrical power. While performing other tasks, the robot may be untethered and reliant on an electrical power source onboard the robot.

Computer vision can help machines to identify and understand objects and people in images and videos. In some implementations, computer vision can seek to perform and automate tasks that replicate human capabilities. In augmented reality applications, for example, physical objects can be detected and tracked in real-time, and used to place virtual objects in a physical environment. Self-driving cars can use real-time object identification and tracking to understand a car's environment and to direct movement of the car accordingly. In manufacturing, computer vision can monitor manufacturing machinery for maintenance purposes, product quality and/or packaging on a production line, for example.

Computer vision can include depth characterization, i.e., characterizing a distance of an object from a camera. Depth characterization may include depth estimation. Depth characterization is important in applications such as advanced driver assistance systems (ADAS), autonomous vehicles, robot operation, and robot navigation. For example, robots can use depth characterization for motion planning, and grasping and manipulating objects, and interacting with objects in the robot's environment.

Depth characterization can be performed by LiDAR, for example. Depth characterization can also be performed by a stereo vision system. Stereo vision can include extracting 3D information about a scene or an environment from multiple 2D views. Stereo vision can be used to estimate the distance of objects of interest from a camera, for example.

### BRIEF SUMMARY

A stereo vision system may be summarized as comprising a first camera, a second camera, the second camera separated from the first camera by a first baseline, and a third camera, the third camera separated from the second camera by a second baseline, the second baseline greater than the first baseline, wherein the stereo vision system is operable to determine a first depth characterization of a first object using data received from the first camera and the second camera, and operable to determine a second depth characterization of a second object using data received from the second camera and the third camera, the second object being farther away from the stereo vision system than the first object.

In some implementations, the third camera is separated from the first camera by a third baseline, the third baseline greater than the second baseline, and the stereo vision system is operable to determine a third depth characterization of a third object using data received from the first camera and the third camera, the third object being farther away from the stereo vision system than the second object. The third baseline may be the sum of the first baseline and the second baseline.

In some implementations, a respective position and orientation of each of the first camera, the second camera, and the third camera are rigidly fixed with respect to each other.

In some implementations, each of the first camera, the second camera, and the third camera is a respective video camera.

In some implementations, the stereo vision system is further operable to form a stereo disparity map, the stereo disparity map which includes at least the first object, and the stereo disparity map is based at least in part on the first depth characterization.

In some implementations, the stereo vision system is further operable to form a stereo pair of images, the stereo pair of images comprising a first image from the first camera and a second image from the second camera.

In some implementations, the second object is different from the first object.

In some implementations, the second object is the first object displaced relative to the stereo vision system.

In some implementations, at least one of the first camera, the second camera, and the third camera includes a pattern projector.

In some implementations, the first object is at a first depth in a first range of depths, the first range of depths extending from a first near-depth to a first far-depth, and the second object is at a second depth in a second range of depths, the second range of depths extending from a second near-depth to a second far-depth, the first near-depth nearer to the stereo vision system than the second near-depth, and the second far-depth farther away from the stereo vision system than the first far-depth. The first far-depth may be equal to the second near-depth. The first range of depths and the second range of depths may overlap each other, and the first far-depth may be farther away from the stereo vision system than the second near-depth.

In some implementations, the first depth characterization includes a first depth, and the second depth characterization includes a second depth.

In some implementations, the first depth characterization includes a position of the first object relative to the second object.

In some implementations, the first depth characterization includes a position of the first object relative to at least one object in an environment of the stereo vision system other than the second object.

In some implementations, the third camera is separated from the first camera by a third baseline, the third baseline greater than the second baseline, and the stereo vision system is operable to determine a third depth characterization of a third object using data received from the first camera and the third camera, the third object being farther away from the stereo vision system than the second object. The first object may be at a first depth in a first range of depths, the first range of depths extending from a first near-depth to a first far-depth. The second object may be at a second depth in a second range of depths, the second range of depths extending from a second near-depth to a second far-depth, the first near-depth nearer to the stereo vision system than the second near-depth, and the second far-depth farther away from the stereo vision system than the first far-depth. The third object may be at a third depth in a third range of depths, the third range of depths extending from a third near-depth to a third far-depth, the second near-depth nearer to the stereo vision system than the third near-depth, and the third far-depth farther away from the stereo vision system than the second far-depth.

A robot may be summarized as comprising a stereo vision system, the stereo vision system comprising a first camera, a second camera, the second camera separated from the first camera by a first baseline, and a third camera, the third camera separated from the second camera by a second baseline, the second baseline greater than the first baseline, wherein the stereo vision system is operable to determine a first depth characterization of a first object using data received from the first camera and the second camera, and operable to determine a second depth characterization of a second object using data received from the second camera and the third camera, the second object being farther away from the stereo vision system than the first object.

In various implementations, the robot includes some or all of the features of the stereo vision system described above.

A method of operation of a stereo vision system, the stereo vision system comprising a first camera, a second camera, and a third camera, the second camera separated from the first camera by a first baseline, the third camera separated from the second camera by a second baseline, the second baseline greater than the first baseline, may be summarized as comprising receiving data from the first camera and the second camera, determining a first depth characterization of a first object using the data received from the first camera and the second camera, receiving data from the second camera and the third camera, and determining a second depth characterization of a second object using the data received from the second camera and the third camera, wherein the second object is farther away from the stereo vision system than the first object.

In some implementations, the method further comprises accessing data describing an environment in a field of view of the stereo vision system, the environment which includes the first object, wherein receiving data from the first camera and the second camera includes activating the first camera and the second camera based at least in part on the data describing the environment.

In some implementations, the method further comprises tracking of the first object, wherein receiving data from the first camera and the second camera includes activating the first camera and the second camera based at least in part on the tracking of the first object.

In some implementations, the method further comprises estimating a disparity, wherein receiving data from the first camera and the second camera includes activating the first camera and the second camera based at least in part on the estimated disparity.

Activating the first camera and the second camera based at least in part on the estimated disparity may include activating the first camera and the second camera when the estimated disparity is at least one of greater than a lower disparity threshold and less than an upper disparity threshold.

In some implementations, the method further comprises forming a stereo disparity map, wherein forming the stereo disparity map is based at least in part on the first depth characterization.

In some implementations, determining a first depth characterization of a first object using the data received from the first camera and the second camera includes rectifying a first image from the first camera with a second image from the second camera, matching at least a portion of the first image to at least a portion of the second image, and determining a disparity between the first object in the at least a portion of the first image and the first object in the at least a portion of the second image. Matching at least a portion of the first image to at least a portion of the second image may include matching a first projected pattern in the at least a portion of the first image to a second projected pattern in the at least a portion of the second image.

In some implementations, the method further comprises receiving at least one of a trigger or a command, wherein receiving data from the first camera and the second camera includes activating the first camera and the second camera based at least in part on the at least one of a trigger or a command.

### BRIEF DESCRIPTION OF THE SEVERAL VIEWS OF THE DRAWINGS

The various elements and acts depicted in the drawings are provided for illustrative purposes to support the detailed description. Unless the specific context requires otherwise, the sizes, shapes, and relative positions of the illustrated elements and acts are not necessarily shown to scale and are not necessarily intended to convey any information or limitation. In general, identical reference numbers are used to identify similar elements or acts.

FIGS. 1A and 1B are schematic front and plan views, respectively, of an example implementations of a stereo vision system, in accordance with the present systems, devices, and methods.

FIGS. 2A and 2B are schematic front and plan views, respectively, of another example implementations of a stereo vision system, in accordance with the present systems, devices, and methods.

FIG. 3 is a block diagram of an example implementation of a portion of robot comprising a stereo vision system, in accordance with the present systems, devices, and methods.

FIG. 4 is a block diagram of an example implementation of a controller, in accordance with the present systems, devices, and methods.

FIG. 5 is a schematic diagram of an example implementation of a robot, in accordance with the present systems, devices, and methods.

FIG. 6 is a schematic diagram of an example implementation of a 3D environment that includes a robot on a surface and objects at various distances from the robot, in accordance with the present systems, devices, and methods.

FIGS. 7A and 7B are schematic isometric and plan views, respectively, of an example implementation of a portion of a 3D environment that includes a robot on a surface and objects at various distances from the robot, in accordance with the present systems, devices, and methods.

FIG. 8 is a flow diagram of an example implementation of a method of operation of a stereo vision system (for example, the stereo vision system of FIG. 3), in accordance with the present systems, devices, and methods.

FIG. 9 is a flow diagram of an example implementation of a method of operation of a stereo vision system (for example, the stereo vision system of FIG. 3) with multiple ranges, in accordance with the present systems, devices, and methods.

### DETAILED DESCRIPTION

The following description sets forth specific details in order to illustrate and provide an understanding of various implementations and embodiments of the present systems, devices, and methods. A person of skill in the art will appreciate that some of the specific details described herein may be omitted or modified in alternative implementations and embodiments, and that the various implementations and embodiments described herein may be combined with each other and/or with other methods, components, materials, etc. in order to produce further implementations and embodiments.

In some instances, well-known structures and/or processes associated with computer systems and data processing have not been shown or provided in detail in order to avoid unnecessarily complicating or obscuring the descriptions of the implementations and embodiments.

Unless the specific context requires otherwise, throughout this specification and the appended claims the term “comprise” and variations thereof, such as “comprises” and “comprising,” are used in an open, inclusive sense to mean “including, but not limited to.”

Unless the specific context requires otherwise, throughout this specification and the appended claims the singular forms “a,” “an,” and “the” include plural referents. For example, reference to “an embodiment” and “the embodiment” include “embodiments” and “the embodiments,” respectively, and reference to “an implementation” and “the implementation” include “implementations” and “the implementations,” respectively. Similarly, the term “or” is generally employed in its broadest sense to mean “and/or” unless the specific context clearly dictates otherwise.

The headings and Abstract of the Disclosure are provided for convenience only and are not intended, and should not be construed, to interpret the scope or meaning of the present systems, devices, and methods.

The technology described in the present application includes a multi-range stereo vision system for depth characterization. Throughout this specification and the appended claims, the term “depth characterization” is used broadly to encompass approximate depth estimation and precise depth determination.

Robots may use one or more cameras to understand their environment. For example, robots may use cameras to assist with navigating their environment and interacting with objects in the environment. Humanoid robots, for example, may use cameras similarly to the way humans use eyes.

Depth characterization of objects in an environment can be important. Humans, for example, can have binocular vision which provides depth characterization of objects in their environment. Conventional stereo vision systems can use two cameras to achieve a similar effect. Depth characterization can include an estimated depth e.g., an estimated distance from the stereo vision system to the object. Depth characterization can include a positioning of objects in 3D relative to one another and/or relative to the stereo vision system.

Depth can be characterized at least in part from a disparity in a position of an object in images taken by two cameras where the two cameras are separated by a distance referred to in the present application as a baseline. The disparity can be proportional to the baseline, e.g., a longer baseline can result in greater disparity between the object's position in the two images. It can be advantageous to design a stereo vision system with a baseline between the cameras that is long enough to provide sufficient disparity in an object's position to achieve a desired precision in a measurement of the object's depth. If the baseline is too short, then the disparity can be too small to achieve the desired precision.

The disparity can be inversely proportional to the distance of an object from the stereo vision system. Consequently, the disparity can increase non-linearly as the distance between the object and the stereo vision system decreases. The increased disparity can come at an increased computational cost to the stereo vision system as described below.

In some implementations, stereo vision systems determine disparity by first identifying a respective position of the object in each image, and then measuring the displacement of the object in one image relative to the other image. In some implementations, stereo vision systems use a matching process in which a template formed at least in part from a region that includes the object in the first image is used to scan the second image to find a corresponding region that includes the object in the second image. In other implementations, stereo vision systems use a matching process in which a template formed at least in part from prior knowledge is used to scan the first and the second images to find regions that include the object in the first and the second images.

In various of the above implementations, the first and the second images are digital images, and the regions include pixels. In some implementations, the stereo vision system is a parallel stereo vision system and scanning can be performed along a scan line. Matching may include determining a sum of squared differences and/or a sum of absolute differences, for example. In some implementations, the stereo vision system includes a pattern projector.

A depth map can be generated by determining a respective disparity for each of at least some of the pixels in the two images. In an RGB (red/green/blue) three-channel colour system, the depth map may be provided as a fourth channel of information.

In general, a larger disparity can result in a computationally more expensive matching process. If an object is separated by a greater distance in the first and the second images, then the matching process can include scanning over a larger region. For digital images, the size of the search space in pixels in the matching process can be larger when the disparity is larger. If the object is closer together in the first and the second images, then the matching process can include scanning over a smaller region and can be computationally more efficient. For digital images, the size of the search space in pixels in the matching process can be smaller when the disparity is smaller.

In some implementations, the size of the search space in pixels has an upper limit (e.g., for reasons of computational efficiency). In these implementations, the stereo vision system has a lower limit on the proximity of an object for which depth of the object can be characterized.

It can be desirable when characterizing the depth of an object farther away from the stereo vision system to use a longer baseline to be able to compute the depth with sufficient precision. It can be desirable when characterizing the depth of an object closer to the stereo vision system to use a shorter baseline for computational efficiency.

In general, there can be a range of depths over which a particular baseline between cameras provides depth characterization with sufficient precision and computational efficiency. Each range of depths can be defined by a near-depth dₙₑₐᵣ and a far-depth d_{far} which are lower and upper bounds, respectively, of a depth interval [dₙₑₐᵣ,d_{far}] expressed as follows:

dₙₑₐᵣ≤d≤d_{far}

where d=depth.

A conventional stereo vision system comprising a pair of imaging cameras has a fixed range of depths over which a baseline between the cameras can provide depth characterization with sufficient precision and computational efficiency. It can be desirable for a stereo vision system to be operable to provide depth characterization with sufficient precision and computational efficiency in more than one range of depths, for example, a first range [d_{1,near}, d_{1, far}] and a second range [d_{2,near}, d_{2,far}]. Ranges may overlap with one another (e.g., d_{1,far}>d_{2,near}). Ranges may be contiguous (e.g., d_{1,far}=d_{2,near}).

One approach to a multi-range stereo vision system for depth characterization is to employ multiple camera systems, each camera system comprising at least two cameras. In this approach, each camera system can be designed for a respective range of depths, e.g., with a baseline between two cameras suitable for a respective range of depths. For example, one camera system can be designed for depth characterization of objects in a range of depths close to the stereo vision system (e.g., with a short baseline between cameras), and another camera system can be designed for depth characterization of objects in a range of depths farther away from the stereo vision system (e.g., with a longer baseline between cameras). A disadvantage of this approach can be that it may require additional camera hardware, power supplies, and computing resources.

Another approach is a multi-range stereo vision system for depth characterization with a variable baseline between cameras. Disadvantages of this approach can include the alignment, control, and calibration of the cameras, and the reliability of moving parts.

The technology described in the present application includes systems, devices, and methods for depth characterization using a stereo vision system. The technology includes a stereo vision system comprising multiple cameras with fixed baselines between two or more camera pairs, in which each camera can belong to more than one camera pair and each camera pair can have a different baseline. Depth characterization of an object may include selecting a suitable camera pair from the two or more camera pairs. Selecting a suitable camera pair may include selecting a camera pair that has a baseline suitable for providing a desired precision with a desired computational efficiency at the given depth.

The technology can be used, for example, by a robot to aid to a) understanding the robot's 3D environment, b) motion planning, routing, and control, and c) interacting with objects in the environment, including grasping and manipulating objects in the environment.

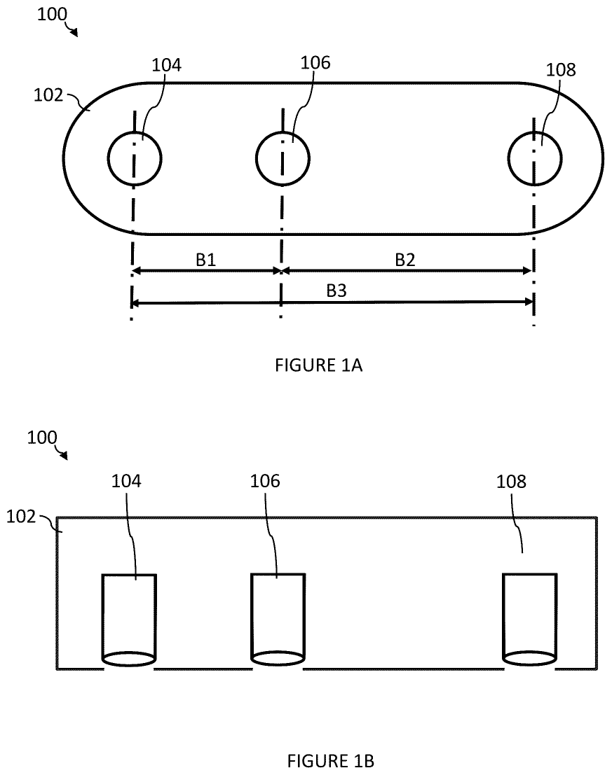

FIG. 1A is a schematic front view of an example implementation of a stereo vision system 100, in accordance with the present systems, devices, and methods. Stereo vision system 100 includes a casing 102, and three cameras 104, 106, and 108. In some implementations, cameras 104, 106, and 108 are video cameras.

Cameras 104 and 106 of stereo vision system 100 are separated by a baseline B1. Cameras 106 and 108 of stereo vision system 100 are separated by a baseline B2. Baseline B2 is longer than baseline B1. Cameras 104 and 108 of stereo vision system 100 are separated by a baseline B3. Baseline B3 is longer than baseline B2. In the example implementation shown in FIGS. 1A and 1B, baseline B3 is equal to the sum of baselines B1 and B2.

FIG. 1B is a schematic plan view of an example implementations of a stereo vision system 100 of FIG. 1A, in accordance with the present systems, devices, and methods.

Stereo vision system 100 is operable to determine a depth of an object using a pair of cameras selected from cameras 104, 106, and 108. The camera pair may be selected based at least in part on a baseline able to determine the depth of the object with sufficient precision and a desired computational efficiency.

Since there are three camera pairs (104 and 106, 106 and 108, and 104 and 108), an environment within a field of view of stereo vision system 100 can be divided into three ranges of depths, e.g., a near range, a mid range, and a far range. For example, an object said to be at near range is defined in the present application as an object at a depth from the stereo vision system that lies within the near range of depths. As described above, each range may have a respective near-depth and far-depth which are lower and upper bounds, respectively, for the depth of objects lying within the range. The ranges may overlap one another. The ranges may be contiguous.

Stereo vision system 100 may select a camera pair based at least in part on which range the object can belong to. For example, if the object is at near range, then stereo vision system 100 may select the camera pair with the shortest baseline, e.g., cameras 104 and 106.

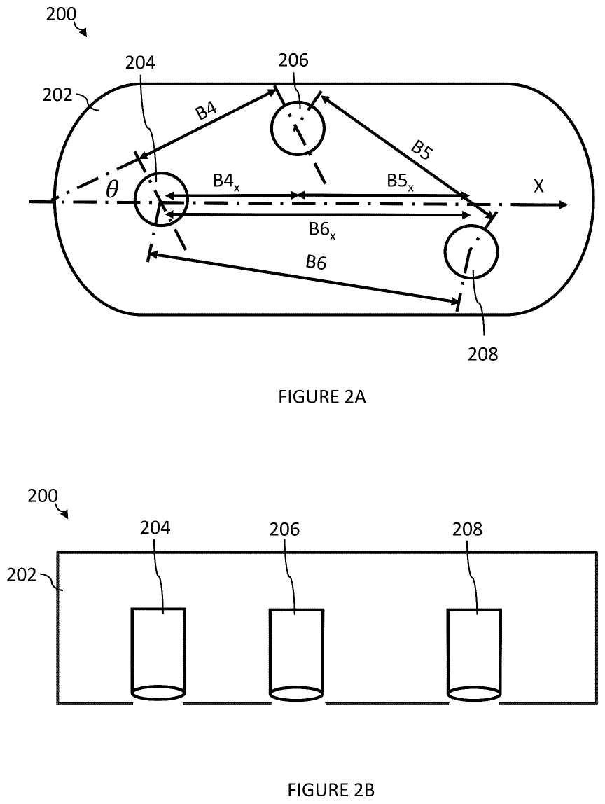

FIG. 2A is a schematic front view of another example implementation of a stereo vision system 200, in accordance with the present systems, devices, and methods. Stereo vision system 200 includes a casing 202, and three cameras 204, 206, and 208. In some implementations, cameras 204, 206, and 208 are video cameras.

Cameras 204 and 206 of stereo vision system 200 are separated by a baseline B4. Cameras 206 and 208 of stereo vision system 200 are separated by a baseline B5. Baseline B5 is longer than baseline B4. Cameras 204 and 208 of stereo vision system 200 are separated by a baseline B6. Baseline B6 is longer than baseline B5. In the example implementation shown in FIG. 2A and 2B, baseline B6 is less than the sum of baselines B4 and B5.

Since disparity can be proportional to the baseline, disparity along a straight line drawn from one camera to another can be proportional to the baseline drawn directly between the two cameras, e.g., baseline B4 of cameras 204 and 206. Disparity in the horizontal direction (e.g., along an X-axis indicated by X in FIG. 2A) can be less by a factor of cos θ where θ is an angle between the direct baseline (e.g., baseline B4, B5, and/or B5) and the X-axis. For a fixed angle θ, disparity along the X-axis can be proportional to the direct baseline. If the stereo vision system characterizes depth by matching images from each camera in the stereo camera pair along the X-axis (see below for more description of matching), then disparity between an object in the images can be proportional to the projection onto the X-axis of the direct baseline, e.g., B4ₓ for cameras 204 and 206, B5ₓ for cameras 206 and 208, and B6ₓ for cameras 204 and 208. In the example implementation shown in FIGS. 2A and 2B, baseline B6ₓ is equal to the sum of baselines B4ₓ and B5ₓ.

FIG. 2B is a schematic plan view of an example implementations of a stereo vision system 200 of FIG. 2A, in accordance with the present systems, devices, and methods.

Operation of stereo vision system 200 can be similar to operation of stereo vision system 100 which is described above with reference to FIGS. 1A and 1B.

In FIGS. 2A and 2B, camera 206 is shown vertically offset upwards relative to camera 204, and camera 208 is shown vertically offset downwards relative to camera 204. In other implementations, cameras 204, 206, and 208 have different vertical offsets relative to one another. A difference between the example implementation of FIGS. 1A and 1B and the example implementation of FIGS. 2A and 2B is that one or more cameras are vertically offset relative to one another. In some implementations, a vertical offset is intentional. In some implementations, a vertical offset arises through imperfect vertical alignment of cameras 204, 206, and 208.

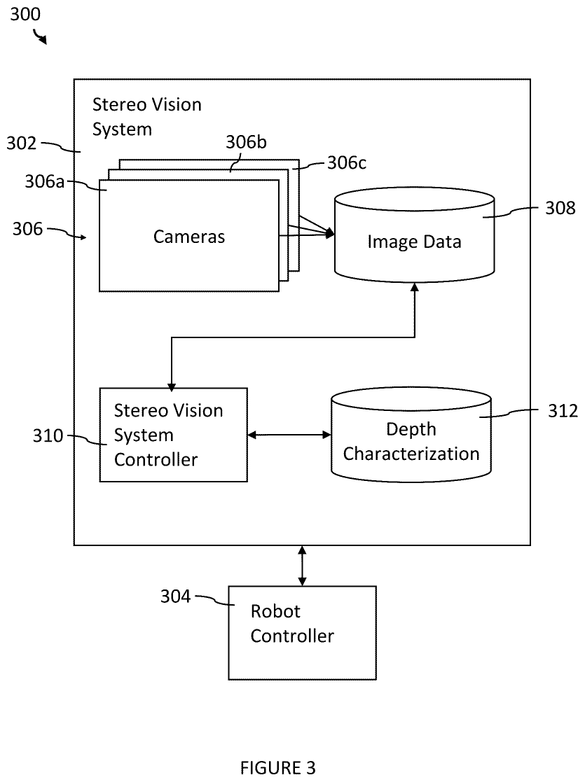

FIG. 3 is a block diagram of an example implementation of a portion 300 of a robot comprising a stereo vision system 302, in accordance with the present systems, devices, and methods. Portion 300 also includes robot controller 304.

Stereo vision system 302 includes cameras 306a, 306b, and 306c (collectively referred to in the present application as cameras 306). In some implementations, cameras 306 have a similar geometry to cameras 104, 106, and 108 of FIGS. 1A and 1B. In some implementations, cameras 306 are not aligned in a horizontal direction e.g., cameras 306 are offset vertically with respect to one another (see, e.g., cameras 204, 206, and 208 of FIGS. 2A and 2B).

Data sensed by cameras 306 can be stored in image data store 308.

Stereo vision system 302 can be controlled by stereo vision system controller 310. Stereo vision system controller 310 may determine a depth characterization of an object in the robot's environment. Stereo vision system controller 310 may select a camera pair based at least in part on which range the object can belong to.

Results of data analysis, including depth characterization of objects in the robot's environment, can be stored in depth characterization store 312.

Robot controller 304 may control operation of stereo vision system 302. For example, robot controller 304 may power stereo vision system 302 on and/or off. Robot controller 304 may pass data from stereo vision system 302 to other systems of the robot, e.g., systems responsible for navigation and/or systems responsible for interacting with objects in the robot's environment.

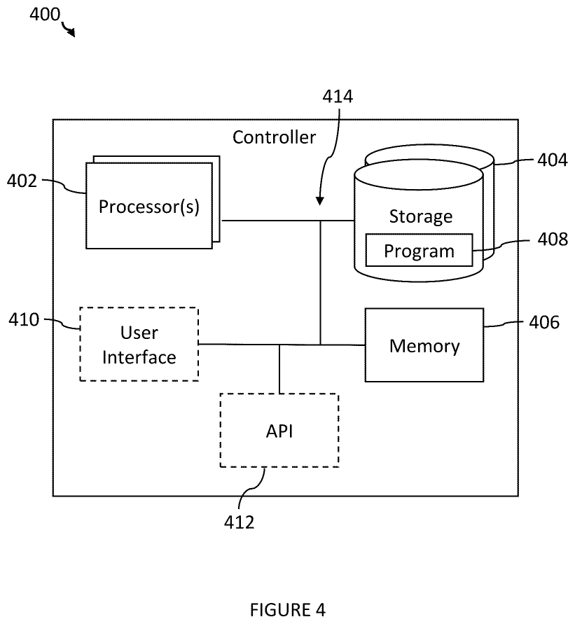

FIG. 4 is a block diagram of an example implementation of a controller 400, in accordance with the present systems, devices, and methods. Controller 400 may be a system controller (e.g., stereo vision system controller 310 of FIG. 3). Controller 400 may be a robot controller (e.g., robot controller 304 of FIG. 3). In various implementations, control functionality may be centralized or distributed.

Controller 400 includes one or more processors 402, one or more non-volatile storage media 404, and non-transitory memory 406. The one or more non-volatile storage media 404 include a computer program product 408.

Controller 400 optionally includes a user interface 410 and/or an application programming interface (API) 412.

The one or more processors 402, non-volatile storage media 404, non-transitory memory 406, user interface 410, and API 412 are communicatively coupled via a bus 414.

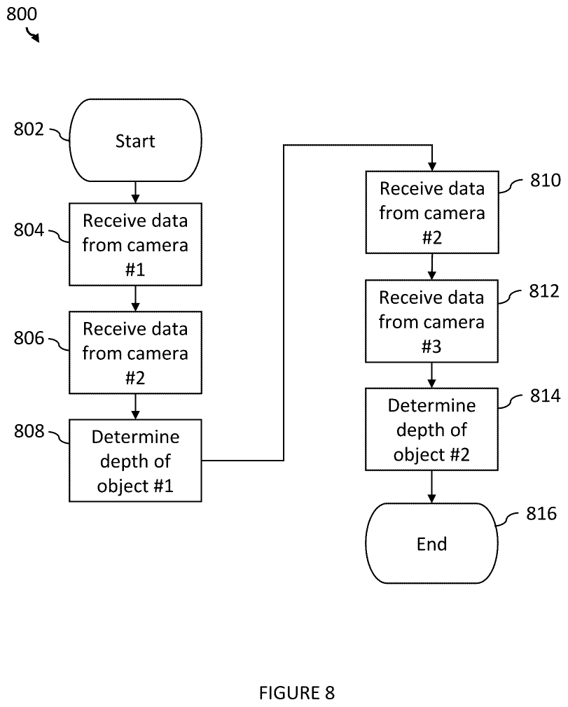

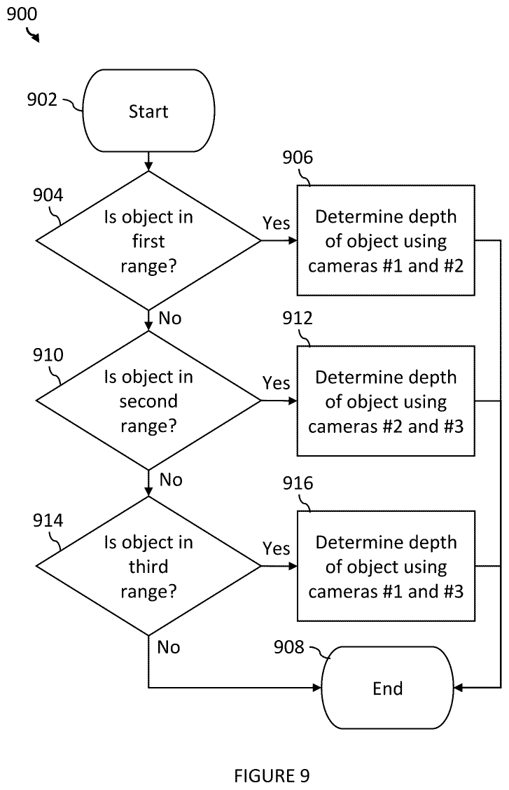

Controller 400 may control and/or perform some or all of the acts of FIGS. 8 and 9 (described below with reference to FIGS. 8 and 9).

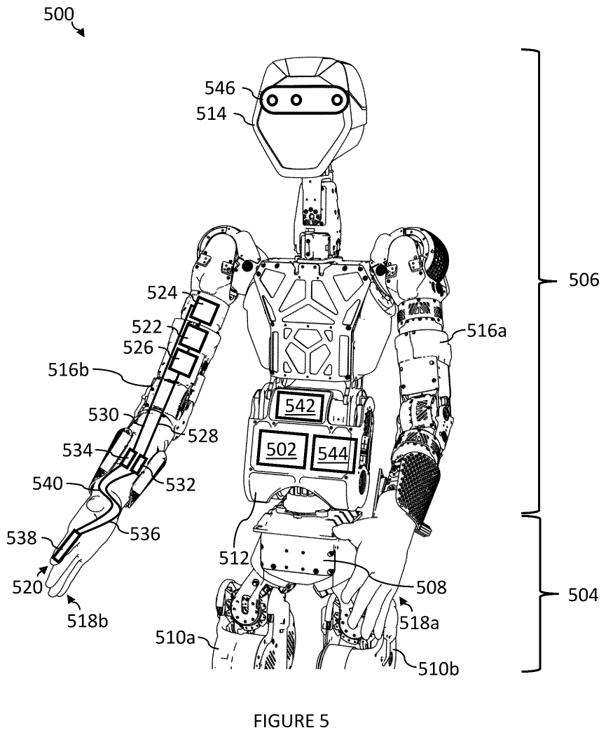

FIG. 5 is a schematic diagram of an example implementation of a robot 500, in accordance with the present systems, devices, and methods. Robot 500 may be autonomous or semi-autonomous. Robot 500 may be a general-purpose robot. Robot 500 may be a robot in a fleet of robots.

Robot 500 may be a humanoid robot. A humanoid robot is a robot having an appearance and/or a character resembling that of a human. In some implementations, robot 500 is capable of autonomous travel (for example, via bipedal walking).

Robot 500 comprises an electrical power source 502. Electrical power source 502 may be at least of a battery, a fuel cell, or a supercapacitor.

Robot 500 further comprises a base 504 and a humanoid upper body 506. Base 504 comprises a pelvic region 508 and two legs 510a and 510b (collectively referred to as legs 510). Only the upper portion of legs 510 is shown in FIG. 5. In other example implementations, base 504 may comprise a stand and (optionally) one or more wheels.

Upper body 506 comprises a torso 512, a head 514, a left-side arm 516a and a right-side arm 516b (collectively referred to as arms 516), and a left hand 518a and a right hand 518b (collectively referred to as hands 518). Arms 516 of robot 500 are also referred to in the present application as robotic arms. Arms 516 of robot 500 are humanoid arms. In other implementations, arms 516 have a form factor that is different from a form factor of a humanoid arm.

Hands 518 are also referred to in the present application as end effectors. In other implementations, hands 518 have a form factor that is different from a form factor of a humanoid hand. Each of hands 518 comprises one or more digits, for example, digit 520 of hand 518b. Digits may include fingers, thumbs, or similar structures of the hand or end effector.

In some implementations, robot 500 is a hydraulically-powered robot.

In other implementations, robot 500 is an electromechanical robot. In yet other implementations, robot 500 is a cable-driven robot.

Electrical power source 502 may be a primary electrical power source. A primary electrical power source is an electrical power source used by robot 500 in normal operation to power electrical and/or electronic components of robot 500 (for example, pump 522 and controller 542).

FIG. 5 shows a single primary electrical power source 502. Those of skill in the art will appreciate that robot 500 may include more than one primary electrical power source. In some implementations, each primary electrical power source is dedicated to a respective designated subset of electrical or electronic components on robot 500. In some implementations, multiple primary power sources may be included to provide redundancy in the event of a failure of one primary power source.

Robot 500 includes a stereo vision system 546. At least some of stereo vision system 546 may be mounted on head 514. Stereo vision system 546 may include stereo vision system 300 of FIG. 3. Stereo vision system 546 may include multiple camera pairs where at least one camera is common to at least two camera pairs.

Stereo vision system 546 may be operable to determine a depth characterization of an object in an environment of robot 500. Stereo vision system 546 may be operable to determine a depth characterization of an object in the environment of robot 500 where the object lies within a range of depths and the camera pair used to determine the depth characterization is selected based at least in part on the range.

Stereo vision system 546 may be operable to determine a depth map of the environment of robot 500. Stereo vision system 546 may be operable to assist navigation of robot 500 through the environment. Stereo vision system 546 may be operable to assist an interaction of robot 500 with objects in the environment.

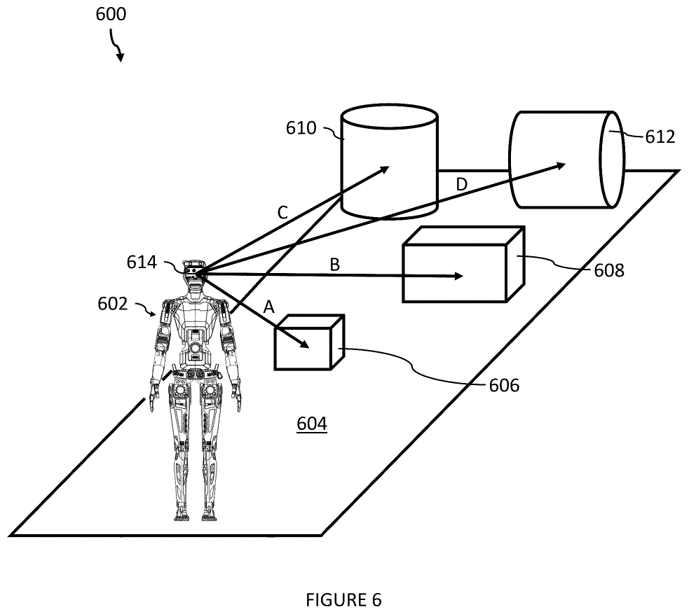

FIG. 6 is a schematic diagram of an example implementation of a 3D environment 600 that includes a robot 602 on a surface 604 and objects 606, 608, 610, and 612 at various distances from the robot, in accordance with the present systems, devices, and methods. For example, surface 604 may be a floor of a room, and objects 606, 608, 610, and 612 may be objects on the floor.

Robot 600 includes a stereo vision system 614 (e.g., stereo vision system 300 of FIG. 3). Stereo vision system 614 is operable to determine a depth characterization of objects 606, 608, 610, and 612. Depth characterization of objects 606, 608, 610, and 612 may include a respective estimated depth of each of objects 606, 608, 610, and 612, where depth is defined as distance from stereo vision system 614 to the object. Depth characterization of objects 606, 608, 610, and 612 may include sensing by one or cameras of stereo vision system 614 as indicated by arrows A, B, C, and D, respectively.

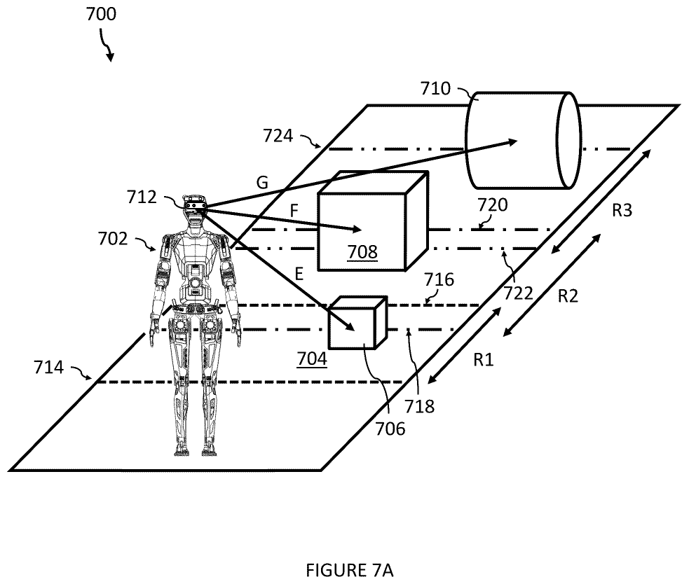

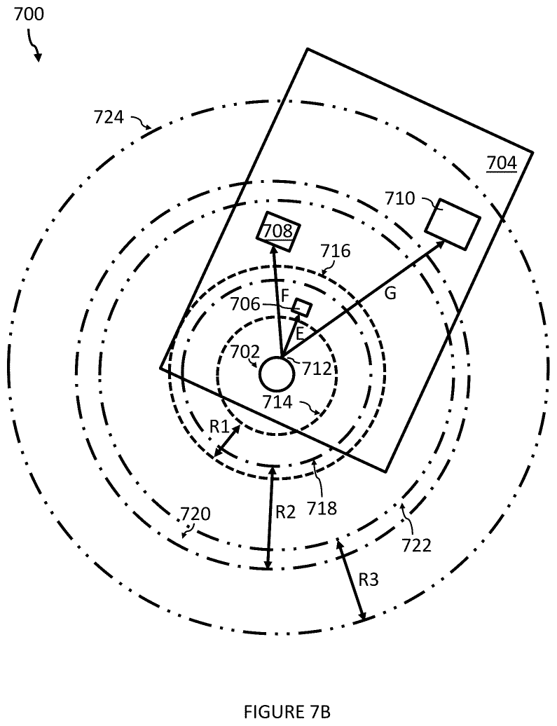

FIG. 7A is a schematic diagram of an example implementation of a portion 700 of a 3D environment that includes a robot 702 on a surface 704 and objects 706, 708, and 710 at various distances from the robot, in accordance with the present systems, devices, and methods.

Robot 700 includes a stereo vision system 712 (e.g., stereo vision system 300 of FIG. 3). Stereo vision system 712 is operable to determine a depth characterization of objects 706, 708, and 710. Depth characterization of objects 706, 708, and 710 may include a respective estimated depth of each of objects 706, 708, and 710. Depth characterization of objects 706, 708, and 710 may include sensing by one or cameras of stereo vision system 712 as indicated by arrows E, F, and G, respectively.

Portion 700 includes three ranges indicated by arrows R1, R2, and R3, and defined by near and far depths 714 and 716, 718 and 720, and 722 and 724, respectively. Object 704 lies in range R1 at depth between near depth 714 and far depth 716. Object 706 lies in range R2 at depth between near depth 718 and far depth 720. Object 708 lies in range R3 at depth between near depth 722 and far depth 724.

For clarity of FIG. 7A, near and far depths 714 and 716, 718 and 720, and 722 and 724 are drawn as straight lines.

FIG. 7B is a schematic plan view of portion 700 of the 3D environment of FIG. 7A, in accordance with the present systems, devices, and methods. Near and far depths 714 and 716, 718 and 720, and 722 and 724 are drawn as circles about robot 702.

FIG. 8 is a flow diagram of an example implementation of a method 800 of operation of a stereo vision system (for example, stereo vision system 300 of FIG. 3), in accordance with the present systems, devices, and methods.

The stereo vision system is operable to determine a respective depth characterization of each of two objects in an environment of the stereo vision system, where the two objects are within a field of view of the cameras of the stereo vision system.

At 802, in response to a starting condition (for example, a controller powering up), the method starts. At 804, the stereo vision system acquires data from a first camera (e.g., camera 306a of FIG. 3). At 806, the stereo vision system acquires data from a second camera (e.g., camera 306b of FIG. 3). In some implementations, the stereo vision system acquires data from more than one camera at the same time, e.g., from the first camera and the second camera. At 808, the stereo vision system determines a depth characterization of a first object in the environment. The depth characterization may be an estimated depth of the first object, i.e., an estimated distance of the first object from the stereo vision system. Receiving data from the first and second cameras at 804 and 806 may include selecting the first and second cameras based at least in part on a baseline between the first and second cameras, where the baseline is suitable for determining the depth characterization of the first object with sufficient precision and a desired computational efficiency, as described above.

At 810, the stereo vision system acquires data from the second camera (e.g., camera 306b of FIG. 3). At 812, the stereo vision system acquires data from a third camera (e.g., camera 306c of FIG. 3). At 814, the stereo vision system determines a depth characterization of a second object in the environment. The depth characterization may be an estimated depth of the second object, i.e., an estimated distance of the second object from the stereo vision system.

Receiving data from the second and third cameras at 810 and 812 may include selecting the second and third cameras based at least in part on a baseline between the second and third cameras, where the baseline is suitable for determining the depth characterization of the second object with sufficient precision and a desired computational efficiency.

The second object may be farther away from the stereo vision system than the first object. The baseline of the second and third cameras may be longer than the baseline of the first and second cameras. The first and second objects may belong to different ranges, e.g., the first object may be at near range, and the second object may be at mid range.

At 816, method 800 ends.

FIG. 9 is a flow diagram of an example implementation of a method 900 of operation of a stereo vision system (for example, stereo vision system 300 of FIG. 3) with multiple ranges, in accordance with the present systems, devices, and methods.

At 902, in response to a starting condition (for example, a controller powering up), the method starts. If, at 904, the stereo vision system determines an object is in a first range of depths, method 900 proceeds to 906 where the stereo vision system determines a depth of the object using a first camera and a second camera. Method 900 proceeds to 908 where method 900 ends. If, at 904, the stereo vision system determines the object is not in the first range of depths, method 900 proceeds to 910.

If, at 910, the stereo vision determines the object is in a second range of depths, method 900 proceeds to 912 where the stereo vision system determines a depth of the object using the second camera and a third camera. Method 900 proceeds to 908 where method 900 ends. If, at 910, the stereo vision system determines the object is not in the second range of depths, method 900 proceeds to 914.

If, at 914, the stereo vision determines the object is in a third range of depths, method 900 proceeds to 916 where the stereo vision system determines a depth of the object using the first camera and the third camera. Method 900 proceeds to 908 where method 900 ends.

If, at 914, the stereo vision system determines the object is not in the third range of depths, method 900 proceeds to 908 where method 900 ends.

In some implementations, the stereo vision system can determine whether the object is in a particular range of depths (e.g., the first, second, and/or third range of depths described above) by testing whether it is possible to characterize the depth of the object using a particular camera pair, e.g., by looking for a match with the object within the search space. In some implementations, the stereo vision system starts with the shortest baseline and, if unsuccessful, proceeds to the next longest baseline, and so on, until a match is found. In other words, the first range tested at 904 may correspond to the shortest range and the shortest baseline (e.g., B1 in FIG. 1A), the second range tested at 910 may correspond to the mid-range with mid-sized baseline (e.g., B2 in FIG. 1A), and the third range tested at 914 may correspond to the longest range and the longest baseline (e.g., B3 in FIG. 1A). However, in alternative implementations, the first range tested at 904 may correspond to the longest range and the longest baseline (e.g., B3 in FIG. 1A), the second range tested at 910 may correspond to the mid-range with mid-sized baseline (e.g., B2 in FIG. 1A), and the third range tested at 914 may correspond to the shortest range and the shortest baseline (e.g., B1 in FIG. 1A).

In some implementations, a baseline between the first and the third cameras is longer than the baseline between the second and the third cameras, and the baseline between the second and the third cameras is longer than the baseline between the first and the second cameras. In some implementations, the baseline between the first and the third cameras is equal to sum of the baseline between the first and the second cameras, and the baseline between the second and the third cameras.

A stereo vision system comprising two discrete stereo camera systems, where each stereo camera system comprises a pair of imaging cameras separated by a respective baseline (for a total of four cameras), can provide a depth characterization of objects in two different depth ranges. A benefit of the multi-range stereo vision technology described above with reference to FIGS. 1 through 9 is that three imaging cameras can provide a depth characterization of objects in three different depth ranges. Moreover, the three cameras can be electrically and mechanically integrated into a single stereo vision system operable as a single multi-range stereo vision system.

In some implementations of the technology described in the present application, data can be acquired from more than one camera pair at the same time. For example, with reference to FIG. 1A, data can be acquired from cameras 104, 106, and 108 at the same time, and subsequently processed to provide depth characterization of objects in more than one range of depths and/or to produce a depth map encompassing more than one range of depths.

The various implementations described herein may include, or be combined with, any or all of the systems, devices, and methods described in U.S. patent application Ser. No. 18/089,517, U.S. patent application Ser. No. 16/940,566 (Publication No. US 2021-0031383 A1), U.S. patent application Ser. No. 17/023,929 (Publication No. US 2021-0090201 A1), U.S. patent application Ser. No. 17/061,187 (Publication No. US 2021-0122035 A1), U.S. patent application Ser. No. 17/098,716 (Publication No. US 2021-0146553 A1), U.S. patent application Ser. No. 17/111,789 (Publication No. US 2021-0170607 A1), U.S. patent application Ser. No. 17/158,244 (Publication No. US 2021-0234997 A1), U.S. Provisional Patent Application Ser. No. 63/001,755 (Publication No. US 2021-0307170 A1), and/or U.S. Provisional Patent Application Ser. No. 63/057,461, as well as U.S. Provisional Patent Application Ser. No. 63/151,044, U.S. Provisional Patent Application Ser. No. 63/173,670, U.S. Provisional Patent Application Ser. No. 63/184,268, U.S. Provisional Patent Application Ser. No. 63/213,385, U.S. Provisional Patent Application Ser. No. 63/232,694, U.S. Provisional Patent Application Ser. No. 63/316,693, U.S. Provisional Patent Application Ser. No. 63/253,591, U.S. Provisional Patent Application Ser. No. 63/293,968, U.S. Provisional Patent Application Ser. No. 63/293,973, and/or U.S. Provisional Patent Application Ser. No. 63/278,817, each of which is incorporated herein by reference in its entirety.

Throughout this specification and the appended claims, infinitive verb forms are often used. Examples include, without limitation: “to provide,” “to control,” and the like. Unless the specific context requires otherwise, such infinitive verb forms are used in an open, inclusive sense, that is as “to, at least, provide,” “to, at least, control,” and so on.

This specification, including the drawings and the abstract, is not intended to be an exhaustive or limiting description of all implementations and embodiments of the present systems, devices, and methods. A person of skill in the art will appreciate that the various descriptions and drawings provided may be modified without departing from the spirit and scope of the disclosure. In particular, the teachings herein are not intended to be limited by or to the illustrative examples of robotic systems and hydraulic circuits provided.

The claims of the disclosure are below. This disclosure is intended to support, enable, and illustrate the claims but is not intended to limit the scope of the claims to any specific implementations or embodiments. In general, the claims should be construed to include all possible implementations and embodiments along with the full scope of equivalents to which such claims are entitled.

1. A stereo vision system comprising:
a first camera;
a second camera, the second camera separated from the first camera by a first baseline; and
a third camera, the third camera separated from the second camera by a second baseline, the second baseline greater than the first baseline, wherein the stereo vision system is operable to determine a first depth characterization of a first object using data received from the first camera and the second camera, and operable to determine a second depth characterization of a second object using data received from the second camera and the third camera, the second object being farther away from the stereo vision system than the first object.

2. The stereo vision system of claim 1, the third camera separated from the first camera by a third baseline, the third baseline greater than the second baseline, wherein the stereo vision system is operable to determine a third depth characterization of a third object using data received from the first camera and the third camera, the third object being farther away from the stereo vision system than the second object.

3. The stereo vision system of claim 2, wherein the third baseline is the sum of the first baseline and the second baseline.

4. The stereo vision system of claim 1, the stereo vision system further operable to form a stereo disparity map, the stereo disparity map which includes at least the first object, wherein the stereo disparity map is based at least in part on the first depth characterization.

5. The stereo vision system of claim 1, wherein the stereo vision system is further operable to form a stereo pair of images, the stereo pair of images comprising a first image from the first camera and a second image from the second camera.

6. The stereo vision system of claim 1, wherein the second object is the first object displaced relative to the stereo vision system.

7. The stereo vision system of claim 1, wherein the first object is at a first depth in a first range of depths, the first range of depths extending from a first near-depth to a first far-depth, and the second object is at a second depth in a second range of depths, the second range of depths extending from a second near-depth to a second far-depth, the first near-depth nearer to the stereo vision system than the second near-depth, and the second far-depth farther away from the stereo vision system than the first far-depth.

8. The stereo vision system of claim 7, wherein the first far-depth is equal to the second near-depth.

9. The stereo vision system of claim 7, wherein the first range of depths and the second range of depths overlap each other, and the first far-depth is farther away from the stereo vision system than the second near-depth.

10. The stereo vision system of claim 1, wherein the first depth characterization includes a first depth, and the second depth characterization includes a second depth.

11. The stereo vision system of claim 1, wherein the first depth characterization includes a position of the first object relative to the second object.

12. The stereo vision system of claim 1, wherein the first depth characterization includes a position of the first object relative to at least one object in an environment of the stereo vision system other than the second object.

13. The stereo vision system of claim 1, the third camera separated from the first camera by a third baseline, the third baseline greater than the second baseline, wherein:
the stereo vision system is operable to determine a third depth characterization of a third object using data received from the first camera and the third camera, the third object being farther away from the stereo vision system than the second object;
the first object is at a first depth in a first range of depths, the first range of depths extending from a first near-depth to a first far-depth;
the second object is at a second depth in a second range of depths, the second range of depths extending from a second near-depth to a second far-depth, the first near-depth nearer to the stereo vision system than the second near-depth, and the second far-depth farther away from the stereo vision system than the first far-depth; and
the third object is at a third depth in a third range of depths, the third range of depths extending from a third near-depth to a third far-depth, the second near-depth nearer to the stereo vision system than the third near-depth, and the third far-depth farther away from the stereo vision system than the second far-depth.

14. A robot comprising a stereo vision system, the stereo vision system comprising:
a first camera;
a second camera, the second camera separated from the first camera by a first baseline; and
a third camera, the third camera separated from the second camera by a second baseline, the second baseline greater than the first baseline, wherein the stereo vision system is operable to determine a first depth characterization of a first object using data received from the first camera and the second camera, and operable to determine a second depth characterization of a second object using data received from the second camera and the third camera, the second object being farther away from the stereo vision system than the first object.

15. A method of operation of a stereo vision system, the stereo vision system comprising a first camera, a second camera, and a third camera, the second camera separated from the first camera by a first baseline, the third camera separated from the second camera by a second baseline, the second baseline greater than the first baseline, the method comprising:
receiving data from the first camera and the second camera;
determining a first depth characterization of a first object using the data received from the first camera and the second camera;
receiving data from the second camera and the third camera; and
determining a second depth characterization of a second object using the data received from the second camera and the third camera, wherein the second object is farther away from the stereo vision system than the first object.

16. The method of claim 15, further comprising estimating a disparity, wherein receiving data from the first camera and the second camera includes activating the first camera and the second camera based at least in part on the estimated disparity.

17. The method of claim 16, wherein activating the first camera and the second camera based at least in part on the estimated disparity includes activating the first camera and the second camera when the estimated disparity is at least one of greater than a lower disparity threshold and less than an upper disparity threshold.

18. The method of claim 15, further comprising forming a stereo disparity map, wherein forming the stereo disparity map is based at least in part on the first depth characterization.

19. The method of claim 15, wherein determining a first depth characterization of a first object using the data received from the first camera and the second camera includes:
rectifying a first image from the first camera with a second image from the second camera;
matching at least a portion of the first image to at least a portion of the second image; and
determining a disparity between the first object in the at least a portion of the first image and the first object in the at least a portion of the second image.

20. The method of claim 19, wherein matching at least a portion of the first image to at least a portion of the second image includes matching a first projected pattern in the at least a portion of the first image to a second projected pattern in the at least a portion of the second image.
